(19) United States
(12) Patent Application Publication
(10) Pub. No.: US 2012/0303426 A1
(43) Pub. Date: Nov. 29, 2012

(54) System and Method for Adding Advertisements to Information Display Systems

(76) Inventors: Tomer Y. Morad, Tel Aviv (IL); Shalom Crown, Givat Shmuel (IL); Shahar Daniel, Kiryat Ono (IL)

(21) Appl. No.: 13/521,247

(22) PCT Filed: Jan. 18, 2011
(86) PCT No.: PCT/IL11/00052

§ 371 Date: Jul. 10, 2012

(30) Foreign Application Priority Data
Jan. 21, 2010 (IL) 203426

(51) Int. Cl. G06Q 30/02

(52) U.S. Cl. 705/14.4

(57) ABSTRACT

The present invention relates to a method for displaying advertisements on a mobile video content display system comprising the steps of: (a) providing a server for receiving, storing, managing and transmitting said advertisements; (b) providing an interface for interacting with said mobile video content display system; (c) providing an advertisements managing component which is logically connected to said interface and capable of managing said advertisements and deciding which of said advertisements should be displayed; (d) providing communication means logically connected to said advertisements managing component for receiving said advertisements and their related information from said server and transmitting said advertisements and their related information to said managing component; (e) providing a repository which is connected to said advertisements managing component for storing said advertisements and their related information; (f) displaying advertisements, selected by said managing component, on said content display system; and (g) tracking which of said advertisements has been displayed and updating said related information of said advertisements in said repository;

### FIELD OF THE INVENTION

The present invention relates to the field of mobile advertisement systems. More particularly, the invention relates to a system and method for adding advertisements to mobile display systems.

### BACKGROUND OF THE INVENTION

As of today, public transportation vehicles often include a display system which presents viewing contents such as news, information, entertainment, or any other video and/or audio contents while traveling.

Conventional mobile display systems typically include a repository for storing the viewing contents, communication means for receiving the viewing contents, a controller for managing the viewing contents and a display for displaying the viewing contents.

Although viewing contents presented to passengers in public transportation vehicles have become widespread over the past years, the presentation of advertisements during travel remains a low priority for media planners. This fact is surprising since passengers of public transportation have long been considered to be an attractive and valued audience by advertisers. During travel, the passengers are a captive audience literally waiting to be engaged. One of the reasons for this situation may be contributed to fact that there is no single format for these display systems, and instead, many different media forms and networks exist for displaying content in public transportation vehicles.

There is still need in the art for such advertisement display systems.

### SUMMARY OF THE INVENTION

It is an object of the present invention to provide a system for presenting advertisements on mobile display systems.

It is another object of the present invention to provide an addition to the mobile content display systems for managing and displaying advertisements.

It is still another object of the present invention to provide a system for updating, prioritizing, managing and displaying advertisements.

Other objects and advantages of the invention will become apparent as the description proceeds.

The present invention relates to a method for displaying advertisements on a mobile video content display system comprising the steps of: (a) providing a server for receiving, storing, managing and transmitting said advertisements; (b) providing an interface for interacting with said mobile video content display system; (c) providing an advertisements managing component which is logically connected to said interface and capable of managing said advertisements and deciding which of said advertisements should be displayed; (d) providing communication means logically connected to said advertisements managing component for receiving said advertisements and their related information from said server and transmitting said advertisements and their related information to said managing component; (e) providing a repository which is connected to said advertisements managing component for storing said advertisements and their related information; (f) displaying advertisements, selected by said managing component, on said content display system; and (g) tracking which of said advertisements has been displayed and updating said related information of said advertisements in said repository;

Preferably, the method for displaying advertisements on a mobile video content display system also comprises the step of communicating the updated related information of the advertisements to the server.

Preferably, the method for displaying advertisements on a mobile video content display system also comprises providing a clock logically connected to the advertisements managing component for indicating the time to said advertisements managing component for displaying advertisements at certain times.

Preferably, the method for displaying advertisements on a mobile video content display system also comprises providing a GPS receiver logically connected to the advertisements managing component for indicating the location to said advertisements managing component for displaying advertisements at certain locations.

Preferably, the communication means comprise of at least one of the following: cellular data communication, Wi-Fi, WiMax, USB, and cable connection.

Preferably, the repository comprises at least one of the following: Hard-Drive and Flash Disk.

In one embodiment, the related information for each of the displayed advertisement is the time and location of display.

In one embodiment, the related information for each of the displayed advertisement is the cost of the exposure of said advertisement as calculated by the advertisements manager.

In one embodiment, the related information for each of the displayed advertisement is the number of passengers that were present on the vehicle during the time the advertisement was displayed.

In one embodiment, the related information for each of the displayed advertisement is the viewer feedback on the displayed advertisements.

In one embodiment, the mobile display system comprises a passenger information system with digital displays.

In one embodiment, the mobile display system comprises a ticketing system with a digital display.

The present invention also relates to a system for displaying advertisements on a mobile video content display system comprising: (a) a server for receiving, storing, managing and transmitting said advertisements; (b) an interface for interacting with said mobile video content display system; (c) an advertisements managing component which is logically connected to said interface and capable of managing said advertisements and deciding which of said advertisements should be displayed; (d) communication means logically connected to said advertisements managing component for receiving said advertisements and their related information from said server and transmitting said advertisements and their related information to said managing component; and (e) a repository which is connected to said advertisements managing component for storing said advertisements and their related information.

### BRIEF DESCRIPTION OF THE DRAWINGS

In the drawings:

FIG. 1 depicts a block diagram depicting the system for managing advertisements on a mobile video content display system.

FIG. 2 depicts a block diagram depicting the mobile system for displaying advertisements on public transportation vehicles according to one embodiment.

FIG. 3 depicts a block diagram depicting the system for managing advertisements for public transportation vehicles according to an embodiment.

### DETAILED DESCRIPTION OF PREFERRED EMBODIMENTS

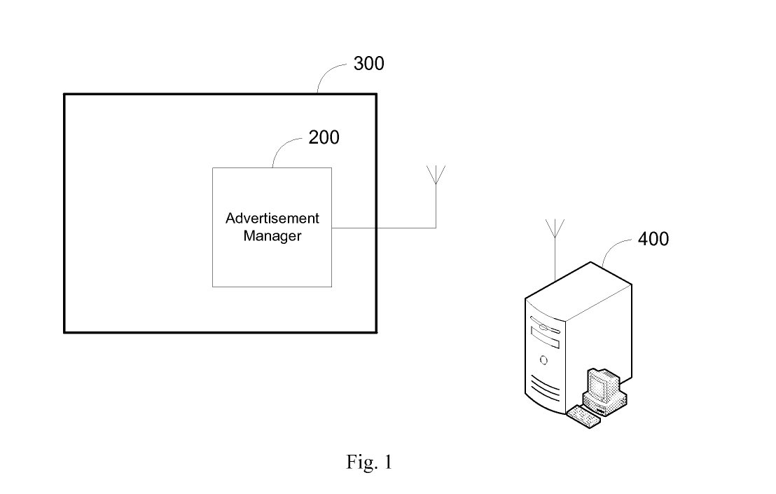

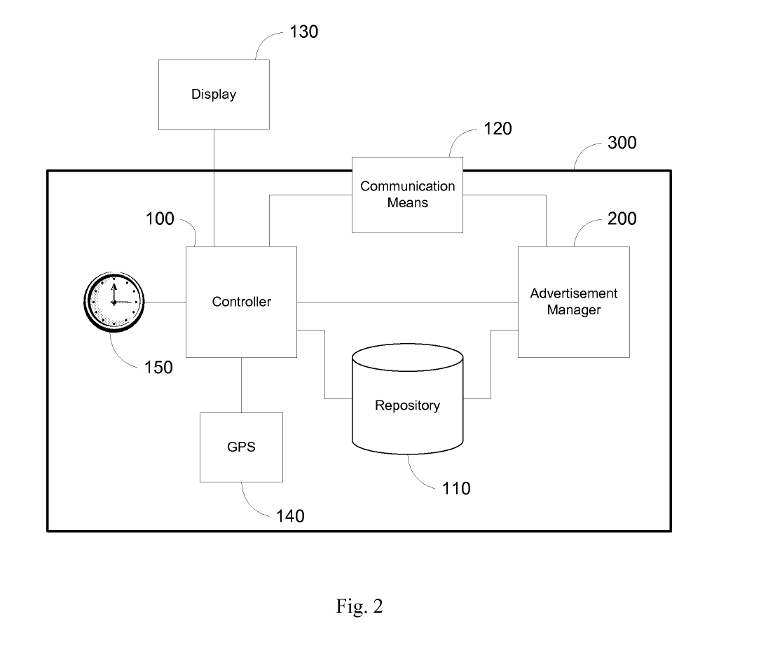

FIG. 1 depicts a block diagram depicting the system for managing advertisements on a mobile video content display system. The term advertisements is meant to include any commercial content which may require updating, selecting, managing, tracking, or billing for displaying to passengers of a vehicle. At first the server 400 is fed with a number of advertisements for public transportation vehicles. The advertisements may be fed directly by the advertisers, loaded from a database, manipulated by a manual or automatic manager, or using any other method of loading commercial contents to server 400. At first the advertisements may be ranked in order to prioritize them. The ranking of the advertisements may be done according to any ranking method such as the bidding method which ranks the advertisements according to their bidding order. For example, the advertising system may be expected to display, in vacant times, only the advertisements with the highest bidding price per exposure. The term exposure is meant to include the displaying of an advertisement. Some of the advertisements may also be intended for a number of public transportation vehicles traveling different routes. Some of the advertisements may have different rankings according to the desired locations, the desired times, and the desired exposures, of their advertisers. For example, the display of a specific advertisement may be confined to appear within 500 meters of an advertiser's business premises, only between 13:00-15:00, only on Tuesdays in the month of January 2010, and at most 10 times per day. The server 400 task is to manage these advertisements and to select which of the advertisements should be transmitted to which vehicle. Once the advertisements have been ranked and selected for a certain vehicle they may be sent to the advertisement manager 200 of that vehicle. An advertisement manager 200 resides in the vehicle computer 300 of each of the participating public transportation vehicles and may be designed in hardware and/or software. The advertisement manager 200 and its functions are described later in relations to FIG. 2. Nevertheless, since the vehicle is traveling, the server cannot count on a permanent connection with the vehicle computer 300. For example, vehicles may be equipped with Wi-Fi communication systems that access the network only in locations where there are Wi-Fi access points. When outside the range from these access points, the vehicle computer must be able to function independently. Moreover, communications bandwidth constraints between the advertisement manager 200 of the vehicle and the server 400 may require that the advertisement manager 200 be allowed to rank the advertisements independently. Therefore, the server 400 is required not only to transmit the advertisements in advance to the vehicle computer 300 but also to transmit the advertisements' related data in order to provide the necessary information to the advertisement manager 200 for deciding which of the advertisements are displayed and where. The transmitting of the advertisements may change according to the communication capabilities of the used communication medium and according to the storage capabilities in the vehicle computer 300. In one embodiment the server 400 may transmit to the advertisement manager 200 of a vehicle only the set of advertisements that have a high probability to be displayed on that vehicle and that their combined overall size does not exceed the storage capabilities of the vehicle computer 300. The advertisements manager 200 is also programmed to track which and where of the advertisements have been displayed and communicate that information back to server 400. In one embodiment, the advertisements manager 200 transmits to the server 400, for each displayed advertisement, the time and location of display. In another embodiment, advertisements manager 200 transmits, following a display of an advertisement, the cost of the exposure after bidding between the advertisements has been calculated in the advertisements manager 200. In yet another embodiment the advertisements manager 200 transmits the number of passengers that were present on the vehicle during the time the advertisement was displayed, where the number of passengers present on the vehicle can be received from the ticketing system, from passenger counting systems, or using any other known method. In another embodiment, the mobile display system has means to collect viewer feedback on the displayed advertisements. By feedback it is meant to include any known method to receive viewer feedback such as touch screen inputs or inputs from personal wireless devices such as mobile phones. This feedback is then transmitted to the server 400. In one embodiment, the server 400 uses the feedback for reports and billing to the advertisers. Once the server 400 receives the information concerning the displayed advertisements from the advertisement manager 200 it may re-rank the advertisements and send the new ranks to other vehicles or that same vehicle. In one embodiment the server 400 receives feedback, such as via text messages from cellular phones, for a displayed advertisement.

FIG. 2 is a block diagram depicting the mobile system for displaying advertisements on public transportation vehicles according to one embodiment. In this embodiment the mobile display system comprises a controller 100 which is connected to a repository 110 and to communication means 120. By the term communication means it is meant to include any known method of communication data such as: cellular data communication, Wi-Fi, WiMax, USB, cable connection, or any other wireless or wired communication or data transfer method. By the term repository it is meant to include Hard-Drive, Flash Disk, or any other known device for storing non-volatile digital information. Advertisement Manager 200 can receive video contents using communication means 120 and can store them in repository 110. By video contents it is meant to include any visual and/or audio content such as: news, information, movie, songs, clips, and advertisements. Controller 100 can display video content on display 130 to the passengers of the public transportation vehicle. The controller 100 may also be connected to a GPS receiver 140 for receiving the coordinates of the present location of the vehicle. Controller 100 may also be connected to a clock 150 for receiving the time. In one embodiment controller 100 provides passengers with information regarding their current stop in the route travelled, the next stops, the estimated times of arrival to the next stops in the route, news casts, etc. The advertisement manager 200 may be implemented in hardware and/or software for managing the advertisements. In one of the embodiments the advertisement manager 200 is stored as a program in repository 110 and run by controller 100. The advertisement manager 200 may have been designed as an initial part of the mobile display system or it may have been added later as an addition to the mobile display system. The advertisement manager 200 function is to receive, store, and manage the advertisements for display on the mobile display system. The advertisement manager 200 is also responsible for removing advertisement content from repository 110. In one embodiment the advertisement manager 200 is also responsible for deciding which of the advertisement content is removed from repository 110 and which should be saved. Advertisement manager 200 may also use probability techniques for deciding which advertisement content should be removed from repository 110 and which advertisement content should be saved for later display. The advertisement manager 200 may also use data from other elements of the mobile display systems such as GPS receiver 140 or clock 150. The advertising manager 200 can request such data from the controller 100. For example, advertisement manager 200 may be programmed to display advertisements of a certain grocery store only in the vicinity of that grocery store. In this example advertisement manager 200 receives the GPS coordinates from GPS receiver 140, and if the received coordinates are within the predetermined vicinity of the store the advertisements connected with that store are displayed. In one of the embodiments, controller 100 is programmed to allow advertisements between the displays of information to the passengers. Thus in this embodiment when the controller 100 decides to allow time for advertisements it requests the advertisement manager 200 to provide a link to an advertisement. At this point advertisement manager 200 selects a suitable advertisement from repository 110 and sends its link to controller 100. In another embodiment, the controller 100 is programmed to allow advertisements to overlay the display of information.

In one embodiment the display 130, as described in relations to FIG. 2, is the display of the ticketing system.

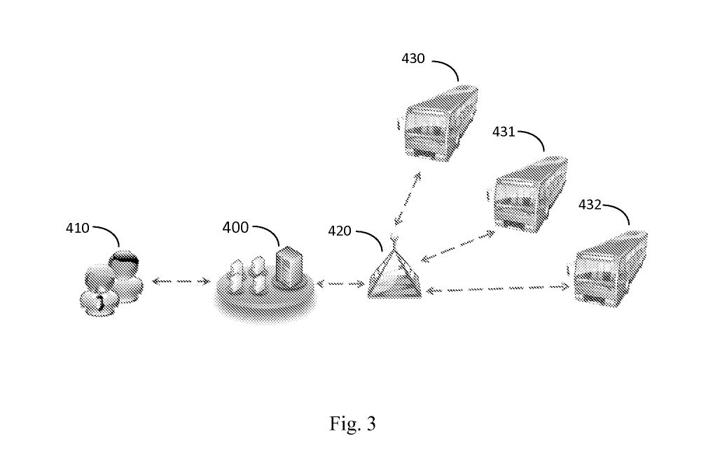

FIG. 3 is a block diagram depicting the system for managing advertisements for public transportation vehicles according to an embodiment. In this embodiment the advertisers 410 can send advertisements to the server 400 with bidding offers related to the locations and times in which they wish to advertise. In one embodiment, the advertisers specify the maximum price they wish to spend for each display of their advertisement. In another embodiment, the advertisers specify a maximum budget for their campaign per day, week, month and/or any period of time. Thus, in this embodiment, the advertising system is expected to bill the advertisers no more than they have specified they are willing to pay. In another embodiment, the advertisers specify the number of passengers they wish to display their advertisement to. In yet another embodiment, the advertisers specify the demographics of the audience they wish to display their advertisement, which may be based on the known demographics for a certain route in a certain location at a certain time, or any other known factor or combination of known factors. Server 400 can then rank all the advertising offers and decide which advertisements are sent to which vehicle of the public transportation vehicles 430-432 and how the advertisements are prioritized. Then server 400 can transmit the advertisements using the cellular communicator antenna 420 to each of the vehicles 430-432. The transmitting of the advertisements and their related data may be done at different times according to the availability of communications with the vehicle. The vehicles 430-432 then update the server 400 of the advertisements they have displayed. For example if server 400 transmitted to vehicle 430 a series of advertisements and their related data, and vehicle 430 has thus displayed some of the advertisements, the information concerning which of the advertisements has been displayed is transmitted back to server 400. Then server 400 may decide to change the ranking of the advertisements and transmit these advertisements related data to vehicle 431 which in turn may change its advertisements ranks. And thus by connecting and updating to vehicles 430-432, server 400 can prioritize and control to a certain extent the display of the advertisements. In addition, after receiving the information from the vehicles about which advertisements were displayed, the server 400 can bill the advertisers 410 accordingly.

In some of the cases the communications between the server 400 and the advertisements manager 200, as described in relations to FIG. 1, is unreliable. Unreliable communication may be due to faulty equipment, unreliable communication infrastructure, or due to the fact that the vehicle carrying the advertisements manager 200 is traveling to places without communication cover. In this case, it becomes impossible for the server 400 to compute in real-time certain performance parameters such as the number of times each advertisement has been shown and/or the accumulated cost for an advertisement campaign. For example, if an advertisement has been distributed to ten vehicles, with a display budget of 500 exposures per day, without reliable communications each advertisement manager 200 may display the advertisement 500 times, which may total at the end of the day 5000 displays instead of 500, as set by the budget. It is therefore desirable that the advertising system should minimize such display errors. In one embodiment, the server 400 changes the ranks for each advertisement, in real time, according to the display data received from the different advertising managers 200. In another embodiment, the server 400 computes the lower bound of the number of displays for each advertisement in real time. When the number of displays exceeds the daily budget, the server 400 sends a message to the advertising managers to stop displaying that advertisement.

In one embodiment, a bidding method is used for ranking advertisements, and the communications between the server 400 and the advertisements manager 200, as described in relations to FIG. 1, is unreliable. In this example, in each vacant advertising spot, the advertisements with remaining daily budgets that can be displayed in the current location and time are selected for display. After that, the advertisements are sorted by their bidding price per display. Following the display of the selected advertisement, the display cost is deducted from the remaining budget of the selected advertisement. For example, three advertisers chose to show their advertisement in a specific stop on a specific bus route during morning hours. Each of the three advertisers allocated a budget of up to $1, $2, and $3 respectively per display, and up to 40$ of daily budget respectively. During the morning hours there are 15 different buses that travel once through the specific stop in that specific route. With a reliable communications system, the third advertiser, i.e. the highest bidder, would be billed $3×13=$39 for 13 displays, leaving the last 2 displays. The last 2 displays should be assigned to the second advertiser who is billed $2×2 for two displays. However, it is enough that one vehicle did not report one of the exposures of the third advertiser, for him to be billed $42. The problem is even graver if there are more buses, as the third advertiser will be over-billed and the second and first advertisers will not get any exposures. Therefore, certain measures are taken to limit over-billing. In one embodiment, each display is reported to the server 400 which in turn re-ranks the advertisements, and communicates the new ranks to the vehicles, meaning that the ranking of an advertisement may be lowered according to its remaining budget. In another embodiment, the ranks computed by the server 400 are dependent on the specific vehicles or specific routes. For example, the server 400 may distribute an advertising budget per vehicle that is traveling on a specific route for a specific date. Continuing with the previous example, if the server 400 expects that there will be 15 buses traveling on that specific route, it would distribute a budget of $3 for that advertisement only to 13 buses. Therefore, in this embodiment the server may also be required to predict the schedule of the vehicles with regards to routes. This schedule can be supplied beforehand to the server 400, or can be computed based on history.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

1. A method for displaying advertisements on a mobile video content display system comprising the steps of:
a. providing a server for receiving, storing, managing and transmitting said advertisements;
b. providing an interface for interacting with said mobile video content display system;
c. providing an advertisements managing component which is logically connected to said interface and capable of managing said advertisements and deciding which of said advertisements should be displayed;
d. providing communication means logically connected to said advertisements managing component for receiving said advertisements and their related information from said server and transmitting said advertisements and their related information to said managing component;
e. providing a repository which is connected to said advertisements managing component for storing said advertisements and their related information;
f. displaying advertisements, selected by said managing component, on said content display system; and
g. tracking which of said advertisements has been displayed and updating said related information of said advertisements in said repository.

2. A method according to claim 1, where the method for displaying advertisements on a mobile video content display system also comprises the step of communicating the updated related information of the advertisements to the server.

3. A method according to claim 1, where the method for displaying advertisements on a mobile video content display system also comprises providing a clock logically connected to the advertisements managing component for indicating the time to said advertisements managing component for displaying advertisements at certain times.

4. A method according to claim 1, where the method for displaying advertisements on a mobile video content display system also comprises providing a GPS receiver logically connected to the advertisements managing component for indicating the location to said advertisements managing component for displaying advertisements at certain locations.

5. A method according to claim 1, where the communication means comprise of at least one of the following: cellular data communication, Wi-Fi, WiMax, USB, and cable connection.

6. A method according to claim 1, where the repository comprises at least one of the following: Hard-Drive and Flash Disk.

7. A method according to claim 2, where the related information for each of the displayed advertisement is the time and location of display.

8. A method according to claim 2, where the related information for each of the displayed advertisement is the cost of the exposure of said advertisement as calculated by the advertisements manager.

9. A method according to claim 2, where the related information for each of the displayed advertisement is the number of passengers that were present on the vehicle during the time the advertisement was displayed.

10. A method according to claim 2, where the related information for each of the displayed advertisement is the viewer feedback on the displayed advertisements.

11. A method according to claim 11, where the mobile display system comprises a passenger information system with digital displays.

12. A method according to claim 11, where the mobile display system comprises a ticketing system with a digital display.

13. A system for displaying advertisements on a mobile video content display system comprising:
a. a server for receiving, storing, managing and transmitting said advertisements;
b. an interface for interacting with said mobile video content display system;
c. an advertisements managing component which is logically connected to said interface and capable of managing said advertisements and deciding which of said advertisements should be displayed;
d. communication means logically connected to said advertisements managing component for receiving said advertisements and their related information from said server and transmitting said advertisements and their related information to said managing component; and
e. a repository which is connected to said advertisements managing component for storing said advertisements and their related information.

14. A system according to claim 13, where the mobile video content display system also comprises a clock logically connected to the advertisements managing component for indicating the time to said advertisements managing component for displaying advertisements at certain times.

15. A system according to claim 13, where the system for displaying advertisements on a mobile video content display system also comprises a GPS receiver logically connected to the advertisements managing component for indicating the location to said advertisements managing component for displaying advertisements at certain locations.

16. A system according to claim 13, where the communication means comprise of at least one of the following: cellular data communication, Wi-Fi, WiMax, USB, and cable connection.

17. A system according to claim 13, where the repository comprises at least one of the following: Hard-Drive and Flash Disk.
